(19) United States
(12) Patent Application Publication
(10) Pub. No.: US 2022/0134324 A1
(43) Pub. Date: May 5, 2022

(54) METHOD FOR PRODUCING MOTOR VEHICLE EXHAUST GAS CATALYSTS

(71) Applicant: UMICORE AG & CO. KG, Hanau-Wolfgang (DE)

(72) Inventors: Martin FOERSTER, Buedingen (DE); Juergen KOCH, Hanau (DE); Astrid MUELLER, Frankfurt (DE); Stéphane MASSON, Village Neuf (FR)

(73) Assignee: UMICORE AG & CO. KG, Hanau-Wolfgang (DE)

(21) Appl. No.: 17/430,379

(22) PCT Filed: Feb. 14, 2020
(86) PCT No.: PCT/EP2020/053837

§ 371 Date: Aug. 12, 2021

(30) Foreign Application Priority Data
Feb. 14, 2019 (DE) 10 2019 103 765.4

(51) Int. Cl. B01J 35/04; B01J 37/02; B01J 37/08

(52) U.S. Cl. CPC B01J 35/04; B01J 37/0244; F01N 3/2066; B01J 37/08; B01J 37/0236; B01J 37/0215

(57) ABSTRACT

The present invention is directed to a method and a device for coating substrates of motor vehicle exhaust gas catalysts. In this respect, the substrates can be flow-though substrates or filter systems (“wall flow”). The invention particularly describes an improvement in such coating processes in which a suspension (washcoat) containing the catalytically active material is applied to or delivered onto such a vertically oriented substrate (monolithic substrate) from above (“metered charge” process).

The present invention relates to a method and a device for coating substrates of motor vehicle exhaust gas catalysts. In this respect, the substrates may be flow-through substrates or filter systems (“wall flow”). The invention particularly describes an improvement in such coating processes in which a suspension (washcoat) containing the catalytically active material is applied to or delivered onto such a vertically oriented substrate (monolithic substrate) from above (“metered charge” process).

The exhaust gas of internal combustion engines typically contains the harmful gases carbon monoxide (CO) and hydrocarbons (HC), nitrogen oxides (NOₓ) and possibly sulfur oxides (SOₓ), as well as particulates that mostly consist of soot residues and possibly adherent organic agglomerates. These are called primary emissions. CO, HC, and particles are the products of the incomplete combustion of the fuel inside the combustion chamber of the engine. Nitrogen oxides form in the cylinder from nitrogen and oxygen in the intake air when the combustion temperatures locally exceed 1400° C. Sulfur oxides result from the combustion of organic sulfur compounds, small amounts of which are always present in non-synthetic fuels. In order to remove these emissions, which are harmful to health and environment, from the exhaust gases of motor vehicles, a variety of catalytic technologies for the purification of exhaust gases have been developed, the fundamental principle of which is usually based upon guiding the exhaust gas that needs purification over a flow-through or wall-flow honeycomb body or monolith with a catalytically active coating applied thereto. The catalyst facilitates the chemical reaction of different exhaust gas components, while forming nonhazardous products, such as carbon dioxide and water.

The flow-through or wall-flow monoliths just described are accordingly also called catalyst substrates, substrates or monolithic substrates as they carry the catalytically active coating on their surface or in the pores forming this surface. The catalytically active coating is often applied to the catalyst substrate in the form of a suspension (washcoat) in a so-called coating operation. Many such processes in this respect were published in the past by motor vehicle exhaust gas catalyst manufacturers (WO9947260A1, EP2521618B1, EP1136462B1).

One important aspect of the production of such heterogeneous catalysts is the precise coating of substrates with a washcoat, particularly with regard to, for example, coating length of the channels of the substrate, coating amount applied, uniformity of the coating layer, uniformity of the coating length and coating gradients along the longitudinal axis of the catalyst substrate, and in the production of layered or zoned coating designs.

In principle, the coating techniques can be divided into two general classes. A first class relates to a coating strategy in which the liquid coating suspension is supplied against gravity to the vertically oriented substrate (substrate body) from below (bottom-up coating). Patent specifications EP2521618B1 and EP1136462B1 are examples of this. The second class of coating techniques discusses the application of the liquid coating slurry onto the top of the vertically oriented substrate and the subsequent introduction thereof into the substrate body (top-down coating). Generally, a measured amount of washcoat is used in these methods, and an excess and loss of expensive raw materials is thus avoided as the entire washcoat remains in the substrate. WO9947260A1 discloses a top-down coating technique in which a coating device for monolithic substrates comprises a device for metering a predetermined amount of a liquid component onto the top of a substrate, wherein said amount is dimensioned such that it is substantially completely accommodated within the substrate. Use is made of a container at the top of the substrate to receive the amount of liquid components, and a device for generating a negative pressure at the bottom of the substrate that is capable of drawing the liquid component from the container into at least one part of the substrate. Further techniques that in this way introduce the coating suspension into a vertically oriented substrate from above can be found, for example, in WO9947260A1 and EP1900442A1. The common feature of these inventions is that the coating suspension is applied from above via a metering nozzle which is mounted centrally above the surface of the catalyst's upper side and has a single outlet opening for the washcoat.

The sometimes highly viscous washcoat suspensions, which generally also have a high flow limit, routinely form an uneven and non-uniform surface when applied from a centrally fixed single nozzle to an uprightly oriented catalyst substrate (monolithic substrate). Generally, a greater amount of coating suspension is located in a circumference below the nozzle than in the edge regions of the end face surface that are further away. During suction into the substrate, this then results in a non-uniform coating front being able to form in the channels and the coating suspension being sucked into the substrate to different extents. In particular in the case of partial coatings for producing zoned products, a homogeneous distribution and uniform zone length are of particular importance in order to ensure that a reproducible, uniform catalytic activity is guaranteed over the entire length and cross-section of the substrate and that there is no uncontrolled overlapping of the zones. Furthermore, by means of the fixed nozzle, it is also not possible to selectively produce regions with different amounts of coating suspension on the upper end face of the substrate before they are introduced into the substrate. The locally limited application of the washcoat through a stationary nozzle leads, in particular in the case of substrates with increasingly larger diameters (e.g. up to 13 inches for heavy duty applications), to the fact that especially higher viscosity or shear-thinning washcoats are no longer distributed uniformly over the entire end face.

One possibility for improving the homogenization of the amount of coating suspension provided above the substrate is described in patent specifications WO2015145122A2, U.S. Pat. No. 9,849,469 and EP0398128A1. EP0398128A1 discloses a method in which the monolithic substrate is rotated during application of the washcoat suspension and the coating suspension is metered from above onto the upper end face of the substrate via a distribution plate having a plurality of holes. This ensures a more uniform application of the washcoat onto the substrate; however, no smoothing or leveling of the surface takes place. With this method, it is also not possible to create regions with a different amount of coating suspension when the washcoat is provided on the end face of the substrate.

Like EP0398128A1, WO2015145122A2 and U.S. Pat. No. 9,849,469 or JP5925101B2 or EP2415522A1 also describe coating methods where the washcoat is added not via a stationary single nozzle but via a multi-hole nozzle system similar to a shower head. WO2015145122A2 describes a process for coating ceramic filters by using a dispensing head for liquids, wherein the dispensing head has a plurality of openings in order to distribute the washcoat uniformly on the end face of the substrate. A similar process for producing a catalyst for exhaust gas purification is disclosed in U.S. Pat. No. 9,849,469 or JP5925101B2 or EP2415522A1. Here, the washcoat is also applied via a dispensing head having a plurality of outlet openings, wherein the outlet openings at the periphery have a larger diameter than the outlet holes in the center of the head. The measures described here lead to the coating suspension being applied more uniformly onto the end face of the substrate. However, a disadvantage of this method is that for each size and geometry of the substrate used, a dispensing head specifically adapted to it must be manufactured and replaced during each product change in the production of the catalysts. This leads to higher costs and set-up times in the production of the coated substrates.

In the art, it is often also required to implement a radially different concentration distribution of the coating suspension on the substrate. In order to achieve this, various coating strategies have previously been applied which attempt to advantageously provide well-coated monolithic bodies in as short a period of time as possible. For example, WO18020777 describes a method for producing coated cylindrical ceramic substrates where the central and peripheral channels have a different coating length with washcoat. For this purpose, a coating suspension is sucked into the vertically oriented ceramic substrate from above and the strength of the suction pulse in the central and peripheral regions is influenced by introducing a metal mesh having regions of different gas permeability into the air stream. The same principle for producing radially different loadings with washcoat is also described in US 2017/0274412.

According to U.S. Pat. No. 6,596,056, for example, catalyst substrates with a radial concentration gradient of washcoat can also be produced by wetting the edge regions of the ceramic substrate with water before applying the washcoat coating. Wetting the channel walls in the outer regions of the substrate reduces the reception capacity for washcoat, resulting in less catalytic material being deposited in the peripheral channels than in the central channels. With these methods, however, only axial and radial coating profiles can be produced with one washcoat composition. Catalyst substrates having coating profiles of two or more different washcoats cannot be produced in this way in a single coating step.

Robot handling systems with an integrated metering unit have been used for quite some time in the art to selectively apply liquids or pasty materials with high precision and flexibility onto surfaces. For example, automated multi-axis robot systems with which the coating compounds can be applied to surfaces quickly and easily even in complex geometries are used for efficient application of adhesives or sealing compounds in the industry. A possible embodiment of such an application system is exemplified in WO2014126675A1.

Although numerous improvements have been developed for applying coating suspensions onto the top of a catalyst substrate, there remains a need for a method with which a predetermined amount of coating suspension is selectively provided on different regions of the end face of a catalyst substrate in a defined distribution in order to be able to thus produce complex structures and defined washcoat distributions in the substrate itself.

It was therefore the object of the present invention to provide a method for coating flow-through and filter substrates for exhaust gas treatment that would make it possible to produce, with great flexibility, at as low a cost as possible and without loss or waste of expensive raw materials, even complex catalytic structures both precisely and uniformly on monolithic substrates. The requirements as regards the layout and the precise and uniform distribution of the coating suspension in the channels of the monolithic substrates of modern exhaust gas catalysts are manifold: zones, multi-layers, defined radial and axial material distribution are necessary in order to meet the increasing demands of exhaust gas treatment.

These and other objects that are obvious from the prior art to a person skilled in the art are achieved by a method and a correspondingly operating apparatus according to independent claims 1 and 11. The subclaims that are dependent on said claims address preferred configurations of the method according to the invention and of the apparatus according to the invention.

The formulated object is achieved by taking the following steps in a method for producing catalytically coated monolithic substrates for exhaust gas aftertreatment, wherein the monolithic substrates have two end faces A and B and an outer surface that extends over a length L from end face A to end face B, and wherein the monolithic substrates are traversed by parallel channels which extend from end face A to end face B:

In a first step a), the monolithic substrate is oriented vertically so that an end face A points upward and the other end face B points downward. In a second step b), a defined distribution of one or more materials inducing the catalytic activity is metered over end face A by using a device that is movable horizontally and optionally vertically above the upper end face A in the x/y direction. In a third step c), the metered material is transported into the monolithic substrate by applying a pressure difference over the monolithic substrate, and finally d) the catalytically coated monolithic substrate is dried and calcined, if applicable. By means of this method, it is possible to very precisely produce even complex coating architectures which cannot be produced, or at least cannot be produced with the same accuracy or simplicity, with the methods and apparatuses shown in the prior art.

The material used in the present invention, which material induces the catalytic activity in the monolithic substrate and forms the so-called washcoat, can be present as a suspension, a liquid, an emulsion or a foam. The washcoat used within the scope of the present invention is one as typically used in the production of motor vehicle exhaust gas catalysts. It is metered over the end face of the monolithic substrate. A configuration of the present method is preferred in which a collar is present around the monolithic substrate in such a way that no washcoat can run down on the outside of the monolithic substrate after metering. In this respect, reference is made to the literature (EP1900442A1; see also FIG. 1).

In the context of the present invention, the consistency of the washcoat should not be such as to immediately run into the channels of the monolithic substrate once metered over the end face, or spread across the surface of the end face in an uncontrolled manner. This can be achieved by various measures. For example, in an advantageous configuration, the rheology of the washcoat can be adjusted in such a way (for example by additives, such as thickeners or thixotropic agents (for example as in WO2016023808A1) or by adjusting the concentration of the constituents (for example, the solid content) or type and amount of solvent used, by adjusting a certain temperature, using a foam, etc.) that it penetrates into the channels only upon application of negative pressure at the lower end face B and/or positive pressure at the upper end face A of the monolithic substrates. Ideally, the coating suspension has a shear-thinning behavior with a flow limit. Here, flow limit means the force necessary to bring a substance into flow; shear-thinning refers to a rheological behavior where the viscosity of a substance decreases as the shear force increases.

The shear-thinning coating medium (washcoat) often has a solid content of between 30 and 52 wt. %. The viscosities of the washcoat are generally between 0.015 and 100 Pa*s, preferably 0.1 to 50 Pa*s and particularly preferably 1 to 50 Pa*s (viscosity: DIN 53019-1, Measurement of viscosities and flow curves by means of rotational viscometers, valid on the date of application). Depending on the chemical composition and additives used, different washcoats have different flow limits. According to the definition of DIN 1342-1 (valid on the date of application), the flow limit is the shear stress above which the sample behaves like a liquid. The flow limit is thus the force needed to destroy the quiescent structure of a fabric and to allow a subsequent flowing as a liquid. According to the interactions of the constituents with one another, these washcoats often have different flow limits of 0.1 to more than 100 Pa, preferably 0.1 to 50 Pa and most preferably 1 to 50 Pa. According to the specification in the example part, the measurement of the flow limits is carried out indirectly by measuring the flow length of the washcoat using a so-called consistometer.

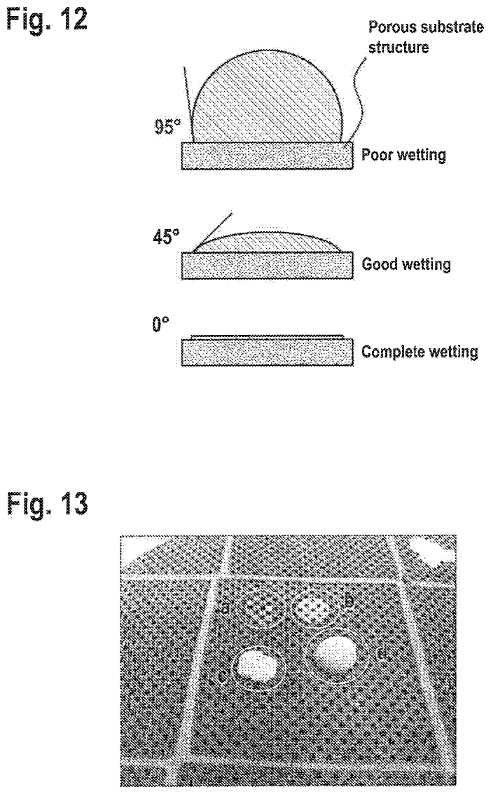

A further possibility according to the invention for preventing premature penetration of the coating medium into the monolith, possibly in addition to setting a flow limit, is the possibility of establishing a contact angle >45°, preferably 60° to 140°, and most preferably 70° to 110° between the coating material and substrate surface A (https://de.wikipedia.org/wiki/Kontaktwinkel). The contact angle is a measure of wettability resulting from the material and porosity of the substrate, the composition of the washcoat and the surrounding gas phase (see also FIG. 12). Complete wettability is to be avoided especially for very porous and thus highly absorbent substrates, since otherwise the washcoat seeps into the substrate without applying a pressure difference (see FIG. 13). FIG. 13 shows the penetration behavior of the washcoat at different contact angles under otherwise identical conditions. The wettability decreases from a to d. The contact angle increases from a to d. In c, the contact angle is just above 0°, while it is >90° in d. The consequence is that the washcoat seeps into the substrate in a and b without a pressure difference being applied beforehand.

Setting a corresponding contact angle can be achieved, for example, by modifying substrate surface A in such a way that corresponding advantageous contact angles form. If the coating material tends to have a hydrophilic character, the substrate surface can, for example, be hydrophobized with an agent known to the person skilled in the art (see, for example, WO2004024407A1). The use of one or more agents selected from the group consisting of hydrophobic waxes such as paraffins, fatty acids or also hydrophobic oils, silicones, siloxanes, silanes or fluorocarbon resins, etc., with which substrate surface A is treated before the coating material is applied, is particularly preferred in this context. An embodiment as mentioned in JP2018103131A2 is also possible and very particularly preferred in this context. A further preferred embodiment in this context is based on the fact that the material inducing the catalytic activity is metered over the end face, wherein a device permeable to this material is located thereon. Said device should be designed such that the material inducing the catalytic activity, despite being sufficiently free-flowing, remains first at or on this permeable device and penetrates into the monolithic substrate only after the pressure difference is applied in step c). This can be achieved, for example, by a hydrophobic surface as specified above and/or by the provision of a device having correspondingly designed openings. Corresponding agents which help to prevent the washcoat suspension from penetrating into the monolithic substrate are meshes, sieves, mats or sponges and are disclosed, for example, in WO9947260A1. Preferably, they may also be hydrophobized. The latter are very well known to the person skilled in the art from the textile and construction industry. There, they are used, for example, as diffusion-permeable water barriers.

It should finally be mentioned that the method according to the invention also provides the step of transporting the applied washcoat into the monolithic substrate. This is done by a further suction or pressure unit. It is also possible and preferred to transport the washcoat into the monolithic substrate by both measures simultaneously. This leads to a more uniform formation of the coating profile in the monolithic substrate. Suction and pressure units of this type are sufficiently familiar to the person skilled in the art (see literature in the introductory part).

For example, for this purpose, a vacuum may preferably be applied at the lower end face of the monolithic substrate by, for example, opening a valve to an evacuated negative pressure tank. At the same time, air or another gas which is inert with respect to the coated monolithic substrate and the washcoat, such as nitrogen, may be supplied under pressure from above the monolithic substrate to the upper end face, if applicable. Likewise, this supply can also be alternated or reversed once or several times, which, according to U.S. Pat. No. 7,094,728B2, results in a more uniform coating of the channels within the substrate bodies.

Instead of applying a negative pressure (“sucking out” the monolithic substrates), a positive pressure may also be applied (“blowing out” the monolithic substrates). For this purpose, air or another gas which is inert with respect to the coated monolithic substrates and the washcoat, such as nitrogen, is supplied under pressure to the upper end face. In this case, the end face opposite the end face to which air/gas pressure is being applied must ensure sufficient outflow of the gas.

The present method may optionally be repeated several times in the same manner from the same surface (e.g. A). In this case, it may be advantageous to carry out a short drying in an advantageous manner between the individual coating runs in order to dry and fix the already applied coating material. This can be done, for example, by having possibly dried and/or heated air flow through the substrate in the coating device itself. In this way, multiple coatings can be produced one on top of the other without separate drying, which coatings have become firmly established in modern motor vehicle exhaust gas catalysts.

However, it is also possible to rotate the substrate by 180° in the coating device after a first coating according to the invention and, if applicable, a drying step as described above, and to repeat a corresponding coating of end face B, which now points upward. Consequently, steps b) to d) are carried out again, but now from the other side of the monolithic substrate. This advantageously makes it possible to produce a zoned coating architecture in the monolithic substrate. In turn, an intermediate drying step as mentioned above may be advantageous.

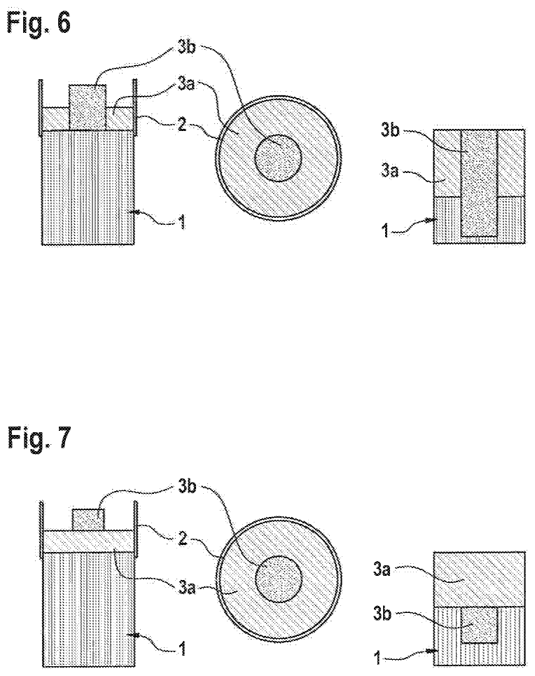

With the present method according to the invention, it is therefore possible to produce complex coating designs in a relatively simple manner. In addition to the aforementioned layered and/or zoned layouts, a plurality of regions of different material composition may be created in the substrate, possibly even with one coating process. In this context, reference is made to FIGS. 6 to 10, which show an exemplary selection of the possible coating designs. By applying several different materials which induce the catalytic activity, simultaneously or successively at different locations to the upper end face, it is possible to produce in a simple manner motor vehicle exhaust gas catalysts that are specifically adapted to the conditions in the exhaust gas system. When simultaneously applying the different washcoats to the end face, care must be taken to ensure that they are not mixed already before being introduced into the monolithic substrate. As already mentioned, adjusting a corresponding rheology of the material that induces the catalytic activity plays a corresponding role here. However, it is also still possible to meter the washcoats successively onto the end face with the aid of the horizontally and optionally vertically movable device such that the first washcoat has already been introduced into the monolithic substrate before applying the second washcoat. Naturally, mixing of the two washcoats can then, or after a possibly short intermediate drying, no longer take place.

The metering device that is movable horizontally and optionally vertically in the x/y direction can be designed according to patterns known to the person skilled in the art. Here, movable horizontally in the x/y direction means that the metering device is arranged movably in a plane above end face A of a substrate in such a way that it can be moved in this plane repeatedly in a defined manner over end face A such as to ensure that the washcoat can be applied to all substrates of a coating champagne in the same way.

The metering device has one or more outlet openings. Preferably, there is only one outlet opening. Since the entire metering device can be moved at least horizontally above the end face of the monolithic substrate, said opening can deposit a defined amount of material inducing the catalytic activity at any point above the end face. This metering device is advantageously also movable in the vertical direction, i.e. in the direction of the monolithic substrate. The use of such three-dimensionally movable metering devices is known to the person skilled in the art
from adhesive technology,
from sealing technology
and from food technology, such as in pastry shops.

Such metering systems for adhesive and sealing technology are offered, for example, by the company ABB Automation, Kuka (kuka robot KR 30) or Loctite (LOCTITE® SCARA Robot). The metering device can preferably meter the same or different materials over the end face. In order to establish complex coating designs, it is thus possible and particularly preferred according to the invention if the metering device with a plurality of outlet openings simultaneously meters, in one step, different materials at corresponding locations over the upper end face of the monolithic substrate. In order to prevent the washcoat from dripping, the outlet openings of the nozzles can be provided with a macropore fabric, a perforated sheet or, for example, a permeable membrane. Alternatively, the outlet openings of the metering device may open or close at different times in order to possibly produce an even more uniform design in the monolithic substrate. For example, the washcoat with the higher flow limit/viscosity can be metered first, followed by the washcoat with the lower flow limit/viscosity. Both washcoats are then transported more uniformly into the monolithic substrate in the next step. It is also conceivable to meter at least two different, correspondingly viscous washcoats, which will thus not mix, one on top of the other. These different coating materials can then be transported into the substrate simultaneously by applying a pressure difference. In contrast, reference should also be made to the already mentioned possibility to transport less viscous washcoats first into the monolithic substrate after metering and optionally to apply a further washcoat from the same side only after fixing. It is also possible to first coat the edge region of the end face of the substrate with a first washcoat and then the inner region of the end face with a second washcoat.

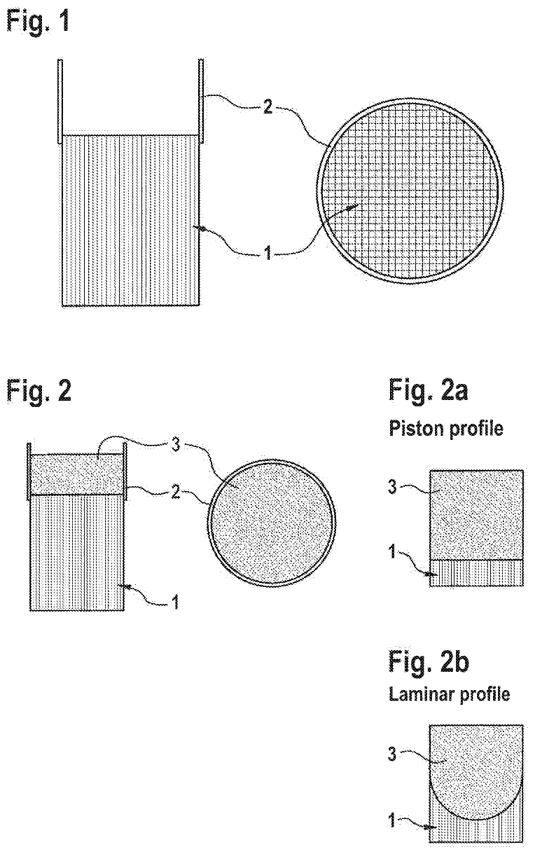

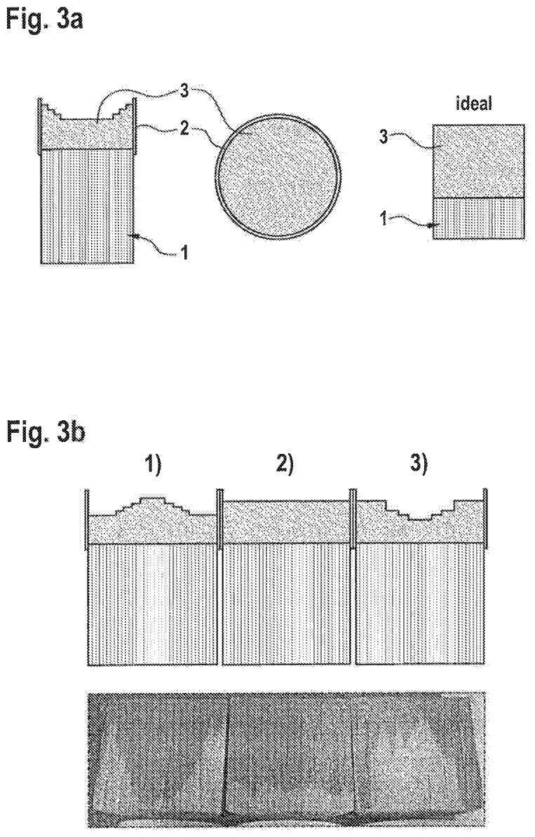

Depending on the rheology of the coating compound, flow conditions when the material is introduced into the monolithic substrate and the substrate properties themselves, different WC distributions can result. FIG. 2a shows an exemplary piston-shaped material distribution and FIG. 2b a laminar profile of a material distribution that can result from uniform coating of the end face with the material. By adjusting the material profile on the end face, the desired material profile in the substrate can be influenced. In order to prevent, for example, a laminar profile from forming in the substrate, one can successfully counteract by using an adapted profile of the coating compound on the end face (FIG. 3a). FIG. 3b shows a real coating where the piston profile in the substrate has been changed in a defined way by this method.

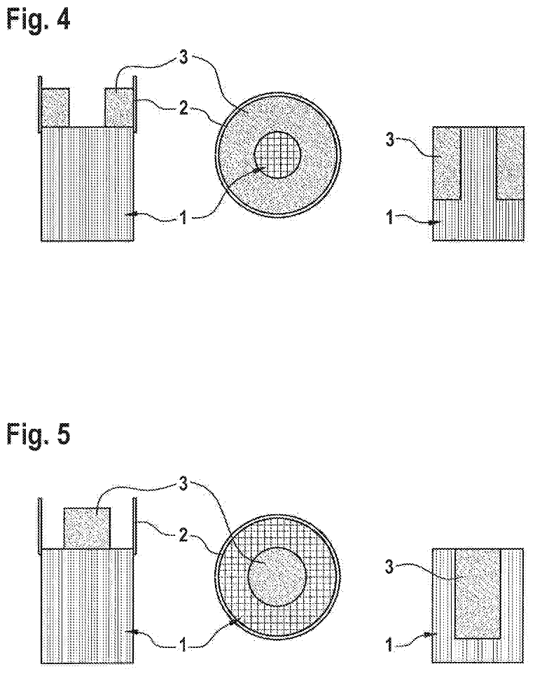

Thus, it is possible to establish different washcoat compositions in the monolithic substrate radially or axially (FIGS. 4-9). An optional intermediate drying step, as mentioned above, can be carried out after the application of a washcoat composition. Optionally, it may be preferred that, after transporting a washcoat into the monolithic substrate, the material inducing the catalytic activity is fixed by chemical measures before a further washcoat is metered. For example, coating architectures having superimposed washcoats can thus also advantageously be produced.

However, washcoat designs having superimposed different washcoat compositions can optionally also be produced accordingly without intermediate drying or chemical fixing. It is particularly advantageous if only enough washcoat is metered over the upper end surface so that all of the material remains in the monolithic substrate when the washcoat is transported into the monolithic substrate in step c). The advantage of this is that promptly after metering over the upper end face of the monolithic substrate and transporting the material into the monolithic substrate, the latter can be reversed and can be provided from the other end face with the same or a different material inducing the catalytic activity. As already stated, zoned arrangements can thus be achieved in a simple manner.

In the method according to the invention, the material metered over the upper end face of the monolithic substrate is transported into the monolithic substrate in step c). For this purpose, a gas flow is established in the corresponding direction by sucking and/or pressing. It has proven to be advantageous if this gas flow is directed in a specific manner. Devices are customary for this purpose which are preferably mounted below the lower end face of the monolithic substrate in the gas stream and which control said gas stream in terms of direction and in terms of velocity. Such fittings are known to the person skilled in the art from fluid mechanics (Dubbel—Taschenbuch für den Maschinenbau, 15th edition, Springer Verlag 1983, Chapter B 6). These include, for example:
diaphragms and diffusers
flow straighteners
baffle plates

These are preferably devices with structures selected from the group consisting of sieves, meshes, diaphragms and baffle plates.

The present invention also provides an apparatus for carrying out the method according to the invention. Said apparatus has:

a) a device for vertically orienting the monolithic substrates,
b) at least one device movable in the x/y direction horizontally relative to the monolithic substrate for metering a material inducing the catalytic activity from above onto the monolithic substrate, and
c) a device for applying a pressure difference over the monolithic substrate to transport the material into the monolithic substrate.

The advantageous embodiments of the described method correspondingly apply mutatis mutandis also to the apparatus according to the invention considered here.

A substrate of the wall-flow type (wall-flow filter) or of the flow-through type can be used here as the substrate. Flow-through monoliths are conventional catalyst substrates in the prior art, which can consist of metal (corrugated carrier, for example WO17153239A1, WO16057285A1, WO15121910A1 and literature cited therein) or ceramic materials. Refractory ceramics, such as cordierite, silicon carbide or aluminum titanate, etc. are preferably used. The number of channels per area is characterized by the cell density, which typically ranges between 200 and 900 cells per square inch (cpsi). The wall thickness of the channel walls in ceramics is between 0.5-0.05 mm.

All ceramic materials customary in the prior art can be used as wall flow monoliths or wall flow filters. Porous wall flow filter substrates made of cordierite, silicon carbide, or aluminum titanate are preferably used. These wall flow filter substrates have inflow and outflow channels, wherein the respective downstream ends of the inflow channels and the upstream ends of the outflow channels are alternately closed off with gas-tight “plugs”. In this case, the exhaust gas that is to be purified and that flows through the filter substrate is forced to pass through the porous wall between the inflow channel and outflow channel, which delivers an excellent particle filtering effect. The filtration property for particulates can be designed by means of porosity, pore/radii distribution, and thickness of the wall. The porosity of the uncoated wall-flow filters is typically more than 40%, generally from 40% to 75%, particularly from 50% to 70% [measured according to DIN 66133, latest version on the date of application]. The average pore size (diameter) of the uncoated filters is at least 7 μm, for example from 7 μm to 34 μm, preferably more than 10 μm, in particular more preferably from 10 μm to 25 μm or most preferably from 15 μm to 20 μm [measured according to DIN 66134, latest version on the date of application]. The completed filters with a pore size of typically 10 μm to 20 μm and a porosity of 50% to 65% are particularly preferred.

As already described, the pressure difference in step c) may be generated by applying a positive pressure to one end of the substrate. Alternatively, the pressure difference may also be produced by applying a negative pressure to the other end of the substrate. Further, it is possible to implement both measures together. A negative pressure is preferably used in the method according to the invention. Most preferably, the gas stream is sucked through the substrate in the direction of coating. Most preferably, air is used for this purpose.

In the method according to the invention, the gas/air stream is generated by a pressure difference of more than 20 mbar between the inlet and outlet sides of the substrate. Further preferably, the process according to the invention operates with a pressure difference for passing the gas stream through from 20 to 600 mbar, particularly preferably from 100 to 500 mbar, between the inlet and outlet sides. It must be taken into account here that larger pressure differences of 50-600 mbar, preferably 100-500 mbar and particularly preferably 150-400 mbar, are useful for the application of wall-flow filters. In the case of flow-through substrates, pressure differences of 20-400 mbar, preferably 50-350 mbar and particularly preferably 80-300 mbar are suitable. In the case of wall-flow filters, the higher minimum pressure difference ensures that small (5-10 μm) and medium (10-20 μm) channels and passages are presumably also accessible through the cell walls for the passage of air, resulting in a lower increase in pressure in the exhaust system for the finished catalyst substrate. This means that more catalytically active material can be available for conversion of the pollutants.

The washcoats considered here are preferably shear-thinning (https://en.wikipedia.org/wiki/Shear_thinning), have solid bodies and contain the catalytically active components or their precursors as well as inorganic oxides, such as aluminum oxide, titanium dioxide, zirconium oxide, cerium oxide or combinations thereof, wherein the oxides can be doped with silicon or lanthanum, for example. Oxides of vanadium, chromium, manganese, iron, cobalt, copper, zinc, nickel, or rare earth metals, such as lanthanum, cerium, praseodymium, neodymium, promethium, samarium, europium, gadolinium, terbium, dysprosium, holmium, erbium, thulium, ytterbium, or combinations thereof may be used as catalytically active components. Noble metals, such as platinum, palladium, gold, rhodium, iridium, osmium, ruthenium, and combinations thereof may also be used as catalytically active components. These metals may also be present as alloys composed of each other or other metals, or as oxides. In the liquid coating medium, the metals may also be present as a precursor, such as nitrates, sulfites, or organyls of the said noble metals and mixtures thereof, and, in particular, palladium nitrate, palladium sulfite, platinum nitrate, platinum sulfite or Pt(NH₃)₄(NO₃)₂ may be used. The catalytically active component can then be obtained from the precursor by calcination at about 400° C. to about 700° C.

Metal ions from the group of platinum metals, in particular platinum, palladium and rhodium, for example, have proven suitable for the oxidation of hydrocarbons, while for example the SCR reaction has been shown to be most effective with zeolites or zeotypes (molecular sieves with other or further elements as cations in the framework as compared to zeolites) exchanged with iron and/or copper ions. The material (washcoat) inducing the catalytic activity can hence also contain zeolites or zeotypes. In principle, all types or mixtures of zeolites or zeotypes suitable to the person skilled in the art for the corresponding field of application can be used. These include naturally occurring but preferably synthetically produced zeolites. These can have framework types, for example, from the group consisting of beta, ferrierite, Y, USY, ZSM-5, ITQ. Examples of synthetically produced small-pore zeolites and zeotypes that are suitable here are those that belong to the structure types ASW, ACO, AEI, AEN, AFN, AFT, AFX, ANA, APC, APD, ATN, ATT, ATV, AWO, AWN, BIK, BRE, CAS, COO, CHA, DOR, DFT, EAB, EDI, EPI, ERI, ESV, GIS, GOO, IHW, ITE, ITW, JBW, KFI, LEV, LTA, LTJ, MER, MON, MTF, NSI, OWE, PAU, PHI, RHO, RTE, RTH, SAS, SAT, SAV, SIV, THO, TSC, UEI, UFI, VNI, YUG and ZON. Preferably used are those of the small-pore type which are derived from a structure type from the group consisting of CHA, LEV, AFT, AEI, AFI, AFX, KFI, ERI, DDR. Those derived from the CHA, LEV. AEI, AFX, AFI or KFI framework are particularly preferred here. A zeolite of the AEI or CHA type in this context is very particularly preferred. Mixtures of the mentioned species are also possible. The SAR value of the zeolite or the corresponding value in the zeotype (e.g. SAPO->(Al+P)/2Si) should be in the range from 5 to 50, preferably 10 to 45 and most preferably 20 to 40. For a correspondingly good activity, for example in the SCR reaction, it is necessary for the zeolites or zeotypes and in particular those of the small pore type to be exchanged with metal ions, in particular transition metal ions. Here, the person skilled in the art can use the metal ions, in particular copper ions, which can preferably be used for the corresponding reaction. The person skilled in the art will know how such an ion exchange can take place (for example WO2008/106519A1). The degree of exchange (number of ions at exchange sites/total number of exchange sites) should be between 0.3 and 0.5. What is meant here by exchange sites are those at which the positive ions compensate for negative charges of the mesh. Further non-exchanged metal ions, in particular Fe and/or Cu ions, can preferably also be present in the final SCR catalyst. The ratio of exchanged to unexchanged ions is >50:50, preferably 60:40-95:5 and more preferably 70:30-90:10. The ions seated on exchange sites are visible in electron spin resonance analysis and can be quantitatively determined (Quantitative EPR, Gareth R. Eaton, Sandra S. Eaton, David P. Barr, Ralph T. Weber, Springer Science & Business Media, 2010). All non-ion exchanged cations are located at other locations within or outside the zeolite/zeotype. The latter do not compensate for a negative charge of the zeolite/zeotype framework. They are invisible in EPR and can thus be calculated from the difference between the total metal loading (for example determined by ICP) and the value determined in the EPR. The addition of the corresponding ions to the coating mixture is controlled in such a way that the total amount of metal ions, in particular Fe and/or Cu ions, is 0.5-10% by weight, preferably 1-5% by weight, of the amount of coating in the final total catalyst.

In addition to the components just discussed, the coating suspension may also contain further constituents. These components can further support the catalytic function of the catalytically active material, but do not actively intervene in the reaction. Materials used here are, for example, so-called binders. The latter ensure, among other things, that the materials and components involved in the reaction can adhere sufficiently firmly to the corresponding substrate. In this context, binders selected from the group consisting of aluminum oxide, titanium dioxide, zirconium dioxide, silicon dioxide or oxide hydroxides thereof (for example boehmite) or mixtures thereof have proven to be advantageous components. Advantageously, high-surface aluminum oxides are used here. The binder is used in a certain amount in the coating. Based on the solid material used in the coating suspension, the further constituent, for example the binder, is used in an amount of max. 25% by weight, preferably max. 20% by weight and very particularly preferably in an amount of 5% by weight 15% by weight.

The monolithic substrates produced with the method according to the invention can generally be used in any exhaust gas aftertreatment known to the person skilled in the art for the motor vehicle exhaust gas field. The catalytic coating of the monolithic substrate may preferably be selected from the group consisting of three-way catalyst, SCR catalyst, nitrogen oxide storage catalyst, oxidation catalyst, soot-ignition coating. With regard to the individual catalytic activities coming into consideration and their explanation, reference is made to the statements in WO2011151711A1.

Monolithic substrates produced by means of the method according to the invention or the apparatus according to the invention can exhibit complex coating designs which previously could not be produced at all or not as easily. The material inducing the catalytic activity can be introduced very selectively into the monolithic substrate. This flexibility helps to develop further improved catalysts not only for the motor vehicle exhaust gas sector, and thus to further advance compliance with the statutory and social demand for cleaner air.

The invention is explained below in more detail by means of the exemplary figures and examples.

FIG. 1: Schematic diagram of a monolithic substrate to be coated with a side view and top view; it shows, in particular, the collar (2) around the upper end face of the substrate, which prevents any washcoat from running down the outer wall of the substrate (1).

FIG. 2: Monolithic substrate (1) with collar (2) and provided coating suspension (3)

FIG. 2a: Theoretical, uniform profile without taking into account the flow conditions.

FIG. 2b: Coating profile in the substrate (1) that ensues after suction.

FIG. 3a: Coating profile using a leveling of coating compound (3) on the upper end face of the monolithic substrate (1)

FIGS. 3b1-3: Results of a real coating test in comparison with (no. 2) and without (nos. 1/3) leveling of the coating compound on the upper end face.

FIG. 4: Annularly provided coating suspension according to the invention for producing a coating (3) in outer regions of the substrate (1)

FIG. 5: Centrally provided coating suspension according to the invention for producing a coating (3) in inner regions of the substrate (1)

FIG. 6: Template according to the invention of the coating suspension (3a, 3b) with different amounts in the central region and the edge regions

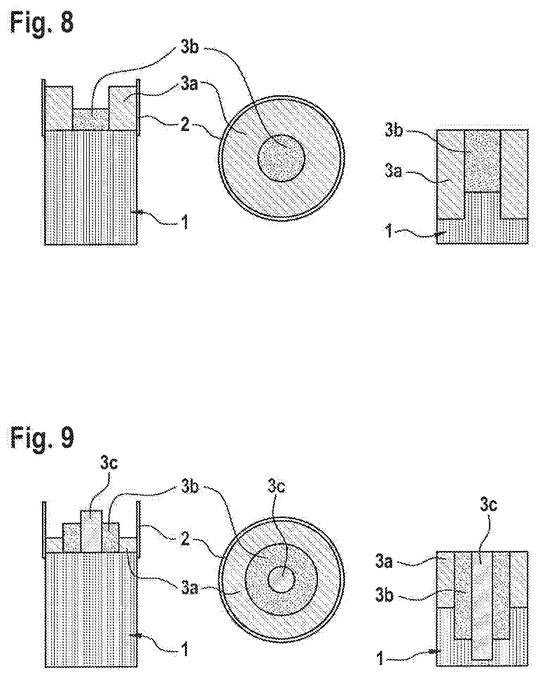

FIG. 8: Template according to the invention of the coating suspension (3a, 3b) with different amounts in the central region and the edge regions

FIG. 9: Template according to the invention of the coating suspension (3a, 3b, 3c) with different amounts in three different regions

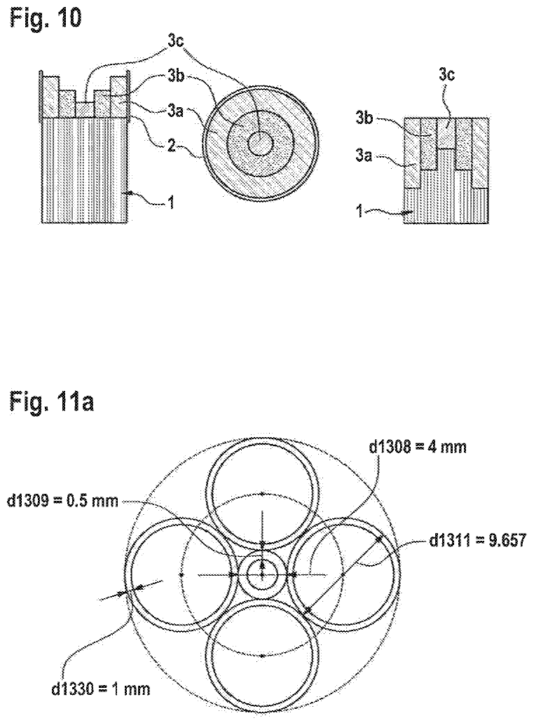

FIG. 10: Template according to the invention of the coating suspension (3a, 3b, 3c) with different amounts in three different regions

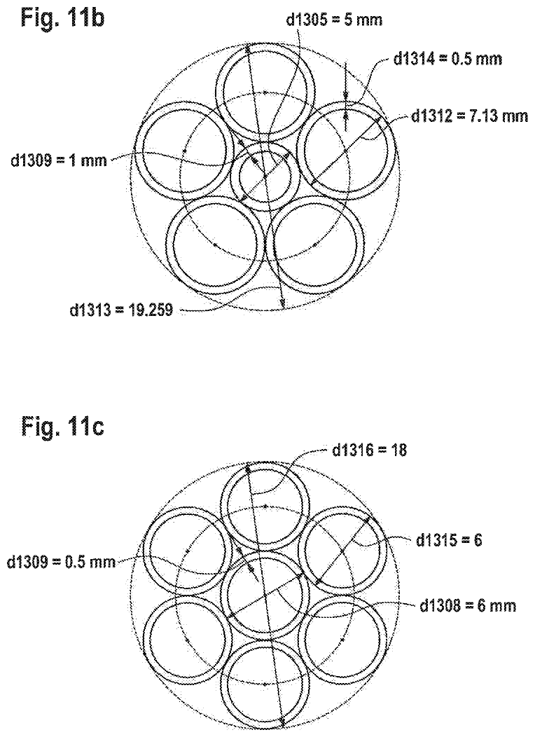

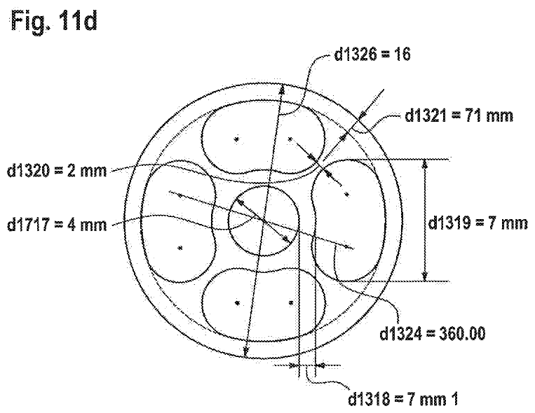

FIG. 11a-d: Possible embodiments of multi-nozzle layouts

FIG. 12: Schematic description of contact angles from 0° to 95° between a porous substrate structure and the coating material

FIG. 13: Real image of contact angles between coating material and substrate <0° to >90 and its consequences

### EXAMPLES

A ceramic substrate (flow-through substrate) made of cordierite having the following features

### Diameter: 118 mm

### Length: 114 mm

Cell density: 93/cm2
Wall thickness: 100 μm
is coated with a washcoat (WC) having a three-way catalyst function. The washcoat has a solid content of 38% (solid dry residue at 350° C.). A simple and rapid measuring method with the Bostwick consistometer ZXCON was used to determine the flow properties of the washcoat (https://www.warensortiment.de/technische-daten/bostwick-consistometer-zxcon.htm). The flow path of a propagating liquid or of a pasty material in a certain time is determined with the Bostwick consistometer. The consistometer consists of a metal channel set up horizontally, which is separated into two differently sized chambers by a vertically movable slider. The washcoat to be measured is filled into the smaller chamber up to a defined height. The larger chamber has a distance scale of 1 cm to 24 cm at the bottom of the channel, on which distance scale the length of the washcoat which has flowed out can be read thirty seconds after the slider has been opened. The flow length is a measure of the flowability of the washcoat (or in other words, the contour stability of the applied washcoat) and physically depends on its viscosity and the flow limit. The washcoat used in this example had a flow length of 3.5 cm and thus a pronounced contour stability.

The washcoat is applied directly to the upper end face of the flow-through substrate in a circular movement using a movable spray nozzle which has a round opening of Ø 7.0 mm. During metering of the washcoat, different, defined WC profiles are generated on the end face

(FIG. 3b1) more WC in the center of the substrate than on the outside
(FIG. 3b2) uniform WC distribution
(FIG. 3b3) more WC on the outside than in the center of the substrate,
so that a defined WC profile is produced in the substrate. In the second step, the washcoat is then sucked into the substrate with a short pulse (250 mbar, 1 sec.), The different WC distributions of the washcoats on the end face also produce different WC distributions in the substrate after coating.

1. Method for producing catalytically coated monolithic substrates for exhaust gas aftertreatment, wherein the monolithic substrates have two end faces A and B and an outer surface that extends over a length L from end face A to end face B, and wherein the monolithic substrates are traversed by parallel channels which extend from end face A to end face B,
characterized in that
a) the monolithic substrate is oriented vertically so that one end face A points upward and the other end face B points downward,
b) a defined distribution of one or more materials inducing the catalytic activity is metered over end face A by using a device which is movable horizontally and optionally vertically relative to the monolithic substrate in the x/y direction, wherein the metering device used has one or more outlet openings, with which a defined amount of material inducing the catalytic activity can be deposited at each point above the end face,
c) the metered material is transported into the monolithic substrate by applying a pressure difference over the monolithic substrate,
d) the catalytically coated monolithic substrate is finally dried and calcined, if applicable.

2. Method according to claim 1,
characterized in that
the material is present as a suspension, a liquid, an emulsion or a foam.

3. Method according to claim 1,
characterized in that
the material as suspensions, emulsions or foam has a flow limit and a contact angle between material and substrate of >45°.

4. Method according to claim 1,
characterized in that
a device permeable to the material is located on the end face so that the material inducing the catalytic activity remains first at or on said permeable device and penetrates into the monolithic substrate only after application of the pressure difference in step c).

5. (canceled)

6. Method according to claim 1,
characterized in that
identical or different materials are metered over the end face.

7. Method according to claim 6,
characterized in that
the different materials are transported into the substrate simultaneously by applying a pressure difference.

8. Method according to claim 1,
characterized in that
in the metering device having a plurality of outlet openings, the outlet openings open or close at different times when metering the material.

9. Method according to claim 1,
characterized in that
the metering device having a plurality of outlet openings meters different materials simultaneously.

10. Method according to claim 1,
characterized in that
the transporting of the material into the monolithic substrate is controlled by a diffuser mounted below end face B.

11. Apparatus for carrying out a method according to claim 1, characterized in that the following are present:
a) a device for vertically orienting the monolithic substrates,
b) at least one device movable in the x/y direction horizontally relative to the monolithic substrate for metering a material inducing the catalytic activity from above onto the monolithic substrate, and
c) a device for applying a pressure difference over the monolithic substrate to transport the material into the monolithic substrate.
